(19) United States
(12) Patent Application Publication
(10) Pub. No.: US 2004/0021635 A1
(43) Pub. Date: Feb. 5, 2004

(54) Error rejection for optical scroll wheel

(76) Inventor: Wenkwei Lou, San Diego, CA (US)

Correspondence Address: GARLICK HARRISON & MARKISON LLP, P.O. BOX 160727, AUSTIN, TX, 78716-0727, US

(21) Appl. No.: 10/329,726

(22) Filed: Dec. 26, 2002

Related U.S. Application Data
(60) Provisional application No. 60/399,962, filed on Jul. 31, 2002.

(51) Int. Cl. G09G 5/08

(52) U.S. Cl. 345/163

(57) ABSTRACT

An improved optical detection circuit that minimizes false detection of state changes in an optical input device, such as a scroll wheel. Quadrature state change detection circuitry provides a position change interrupt signal only after the active element in the scroll wheel, or other input device, has caused detection circuitry to generate an output signal indicating that the element has moved at least two quadrature states in a particular direction. Upon detection of movement of the scroll wheel through two successive quadrature states, a “I/O active” signal is generated. The successive changes are determined by an optical encoder that produces a quadrature output signal and by a position change detection circuit that detects whether the wheel has been rotated in a forward or reverse direction between at least two successive quadrature states.

### CROSS REFERENCE TO RELATED APPLICATION

This application claims priority to U.S. Provisional Application Serial No. 60/399,962, filed Jul. 31, 2002, which is incorporated herein by reference in its entirety for all purposes.

### BACKGROUND

1. Technical Field

The present invention relates generally to digital computers; and more particularly to a pointing device, such as an optical mouse, for use with a digital computer wireless interface.

2. Related Art

With the widespread use of operating systems that employ a graphical user interface, computer systems now incorporate a wide range of pointing devices such as computer mice, track balls and other devices that are used to move a cursor on a display screen. In a typical pointing device, such as a mouse or track wheel, a ball is rotated in a housing by the movement of the device over a surface or by the user's finger. As the rotating ball turns, one or more encoder shafts in the housing rotates about a pair of orthogonal axes (“X” and “Y”) to produce signals that correspond to the motion of the pointing device along these orthogonal axes. The signals are processed to generate a data stream indicating the position of the device on the respective X and Y axes.

In recent years, a number of programs have been adapted to make use of a third axis, commonly referred to as the “Z” axis. One of the primary examples of use of a “Z” axis is in connection with scrolling a cursor within a document or for moving an image on a screen display. In most systems employing a scroll wheel, an encoder monitors rotation of the wheel to indicate desired movement up or down the “Z” axis. Most scroll wheels employ detents which provide indications of incremental movements as the wheel rotates to enable the user to scroll a document or display in predetermined increments. Many prior art pointing devices employ a mechanical encoder with a detent mechanism comprising a spring that is biased against the scroll wheel to provide a tactile indication of movement as the spring moves up and down over mechanical indentations in the scroll wheel.

More recently, pointing devices have incorporated optical encoders to detect the motion of either a mouse ball or a scroll wheel. One of the most commonly used optical encoders produces two channels of square wave signals that are approximately ninety degrees out of phase. The output signal generated by this type of encoder is commonly referred to as a quadrature output. A quadrature output can be processed by a microprocessor to determine both the extent of rotation of the scroll wheel and also the direction of the scroll wheel's rotation.

A typical optical encoder includes a code wheel, an emitter, and a detector circuit. The emitter generally comprises a light emitting diode (LED) that emits radiation which passes through a plurality of spaced teeth in the code wheel. The light rays are collimated into a beam by a lens. The detector circuit is placed on the opposite side of the scroll wheel from the emitter and generally comprises at least two photodetectors. As the scroll wheel is rotated, the light beam from the emitter passes through the slots in the scroll wheel and is detected by the photodetectors. The photodetectors are positioned in a geometry that generates a quadrature output.

Each of the encoders produces an output channel that can be used to generate logic values corresponding to the state of the encoder. The current position of the encoder can be determined by analyzing changes in the state of the encoder. Each change in the state of either of the channels produces either a “+” or a “−” in the output of the respective channels.

One of the most common problems encountered with optical encoders is false detection of a state change. False detection can result from electrical noise, or from “jitter.” In some cases, the Z axis wheel may in fact be stationary; however, the quadrature output circuitry may report a transition of either a +1 or −1. This phenomenon is particularly problematic in the case of wireless devices which enter a power down mode to conserve power when an input/output device is not in use. A false indication of an input signal can cause the interface circuitry to change to an active state, thereby needlessly drawing power when there actually is no input signal to be detected. There is a need, therefore, for an improved optical encoder control circuit that minimizes the effects of false detection of movement of a input/out device such a scroll wheel.

### SUMMARY OF THE INVENTION

The improved optical detection circuit of the present invention minimizes false detection of state changes in an optical input device, such as a scroll wheel. In the present invention, quadrature state change detection circuitry provides a position change interrupt signal only after the active element in the scroll wheel, or other input device, has caused detection circuitry to generate an output signal indicating that the element has moved at least two successive quadrature states in a particular direction. The movement of the scroll wheel is detected by an optical detector circuit that generates quadrature output signals that can be processed to determine whether the wheel has been rotated in a forward or reverse direction through at least two successive quadrature states. Upon detection of movement of the scroll wheel through two successive quadrature states, an “I/O active” signal is generated.

In accordance with the present invention, a method for reducing errors of the detection of the movement of a scroll wheel comprises the steps of: detecting a first signal indicating at least one change in quadrature state of the output signal from a detection circuit, detecting a second change in quadrature state from the output of a detection circuit, comparing the first and second changes in quadrature state to determine whether the wheel has rotated through two successive quadrature states indicating rotation in a forward or reverse direction, and generating an “I/O active” signal after detecting that the scroll wheel has rotated through at least two successive quadrature states in the same direction.

The method and apparatus of the present invention significantly reduces the incidence of false detection of state change. Moreover, other aspects of the present invention will become apparent with further reference to the drawings and specification, which follow.

### BRIEF DESCRIPTION OF THE DRAWINGS

FIG. 1A is a system diagram illustrating a PC host and a wireless mouse that includes a wireless interface device constructed according to the present invention;

FIG. 1B is a system diagram illustrating a PC host and a wireless keyboard that includes a wireless interface device constructed according to the present invention;

FIG. 2 is a schematic block diagram illustrating the structure of a wireless mouse that includes a wireless interface device constructed according to the present invention;

FIG. 3 is a schematic block diagram illustrating the structure of a wireless keyboard that includes a wireless interface device constructed according to the present invention;

FIG. 4 is a block diagram illustrating a wireless interface device (integrated circuit) constructed according to the present invention;

FIG. 5 is a block diagram illustrating a wireless interface unit of the wireless interface device of FIG. 4;

FIG. 6 is a block diagram illustrating a processing unit of the wireless interface device of FIG. 4;

FIG. 7 is a block diagram illustrating an input/output unit of the wireless interface device of FIG. 4;

FIG. 8 is a block diagram generally showing the structure of an integrated circuit constructed according to the present invention with particular detail in the coupling of battery power to the units of the device;

FIG. 9 is a logic diagram illustrating operation according to the present invention; and

FIG. 10 is a logic diagram illustrating operation according to the present invention in controlling the power consumption of a serviced device.

FIG. 11 is an illustration of the possible state transitions for quadrature signals relating to motion of an optical scroll wheel in accordance with the present invention.

FIG. 12A is a timing diagram illustrating a prior art timing sequence for generating interrupt signals in response to transitions of quadrature signals relating to the motion of an optical scroll wheel in accordance with the present invention.

FIG. 12B is a timing diagram illustrating an improved timing sequence for generating interrupt signals in response to transitions of quadrature signals relating to the motion of an optical scroll wheel in accordance with the present invention.

### DETAILED DESCRIPTION

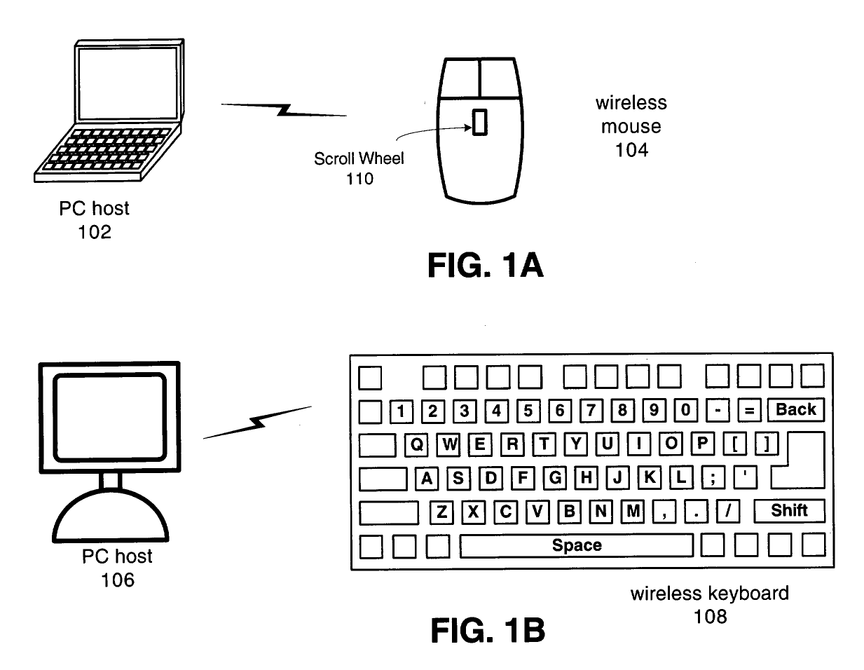

FIG. 1A is a system diagram illustrating a PC host 102 and a wireless mouse 104 that includes a wireless interface device constructed according to the present invention. As shown in FIG. 1A, the PC host 102 wirelessly couples to the wireless mouse 104 that includes a scroll wheel 110. In the structure of FIG. 1A, the wireless mouse 104 includes a wireless interface device that operates to place the wireless mouse in any of a number of reduced power operating modes, including a power down mode in which battery life is substantially extended.

FIG. 1B is a system diagram illustrating a PC host 106 and a wireless keyboard 108 that includes a wireless interface device constructed according to the present invention. The wireless keyboard 108 is battery powered and operates for extended periods of time on a single set of batteries because of the greatly reduced power consumption operations according to the present invention.

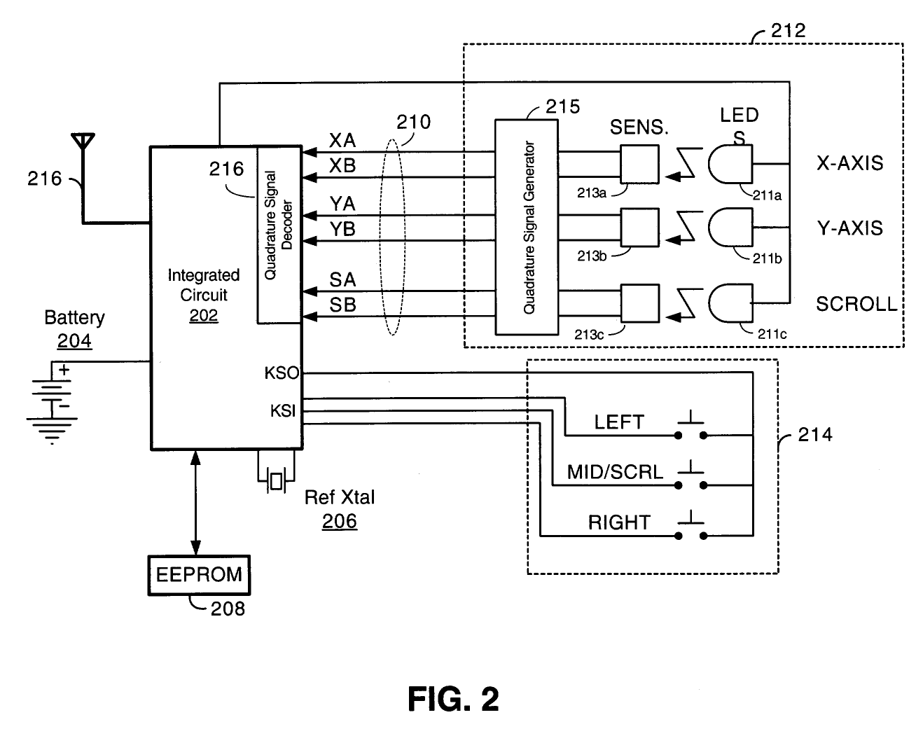

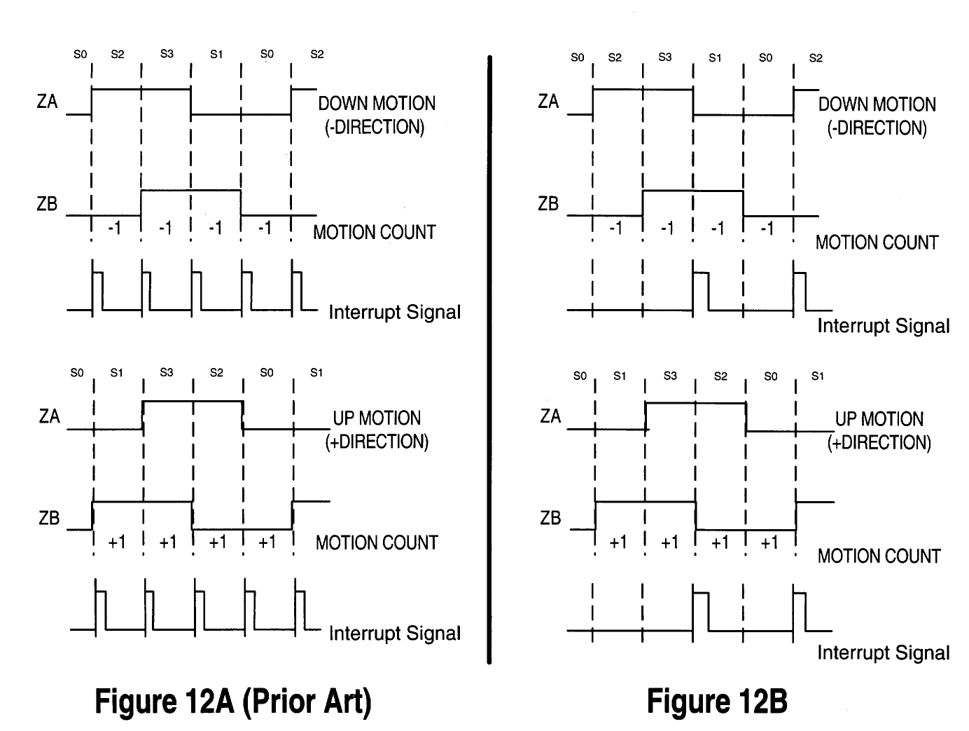

FIG. 2 is a schematic block diagram illustrating the structure of a wireless mouse that includes a wireless interface device constructed according to the present invention. An integrated circuit 202 constructed according to the present invention serves as the wireless interface device and receives various mouse inputs 210 generated by optical detector circuit 212. These mouse inputs 210 include x-axis (XA, XB), y-axis (YA, YB) and scroll (SA, SB). The x-axis; y-axis and scroll signals are often referred to a “quadrature” signals. The x-axis and the y-axis signals are generated by light signals from light-emitting diodes (LEDs) 211a-b that are detected by sensors 213a-b. The scroll wheel signals are generated by light signals from the LED 211c that are detected by the sensor 213c. The output signals from the sensors 213a-c are received by the quadrature signal generator 215. The quadrature signal generator 215 generates quadrature input signals that are detected and decoded by the quadrature signal decoder 216 in integrated circuit 202. The quadrature signal decoder is operable to generate interrupt signals in accordance with the timing diagrams discussed hereinbelow in FIGS. 12A and 12B. The optical encoder and decoder components that produce the quadrature signals are understood by those of skill in the art and are, therefore, not described in detail herein.

Referenced via numeral 214 are the button inputs that are typical with a computer mouse and include the left button input, the middle/scroll button input, and the right button input. As is shown, each of the signals produced by the mouse are received by integrated circuit 202.

Integrated circuit 202 also couples to battery 204, crystal 206 that produces a reference frequency, EEPROM 208, and antenna 216. In one embodiment of the present invention, battery 204 comprises a pair of either AA batteries or AAA batteries. Antenna 216 is an internal antenna in the described because of the size constraints of the mouse and because of the relatively short distance between the PC host and the wireless mouse.

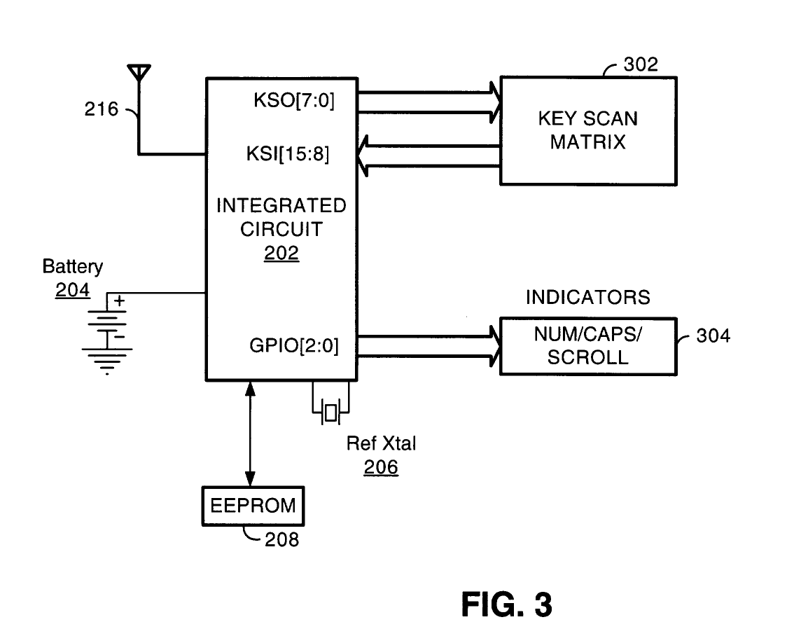

FIG. 3 is a schematic block diagram illustrating the structure of a wireless key scan matrix 302 that operates in conjunction with a wireless interface device (integrated circuit 202) constructed according to the present invention. As shown in FIG. 3, integrated circuit 202 services a key scan matrix O₂ that provides inputs from the keyboard. Indicators 304 include number, capitals, and scroll lights that are lit on the keyboard. The integrated circuit 202 couples to a battery 204, a crystal 206, an EEPROM 208, and an antenna 216.

In another embodiment (not shown in either FIG. 2 or FIG. 3), the integrated circuit 202 services both mouse and keyboard input and may reside internal to either the mouse of the keyboard. As will be apparent to those skilled in the art, multiplexing or signal sharing may be required, because the input signals differ. However, different signal lines may be dedicated for keyboard and for mouse inputs such that no signal sharing is required. As is apparent, when the integrated circuit 202 alone services both mouse and keyboard input wired connectivity between the keyboard and the mouse is required.

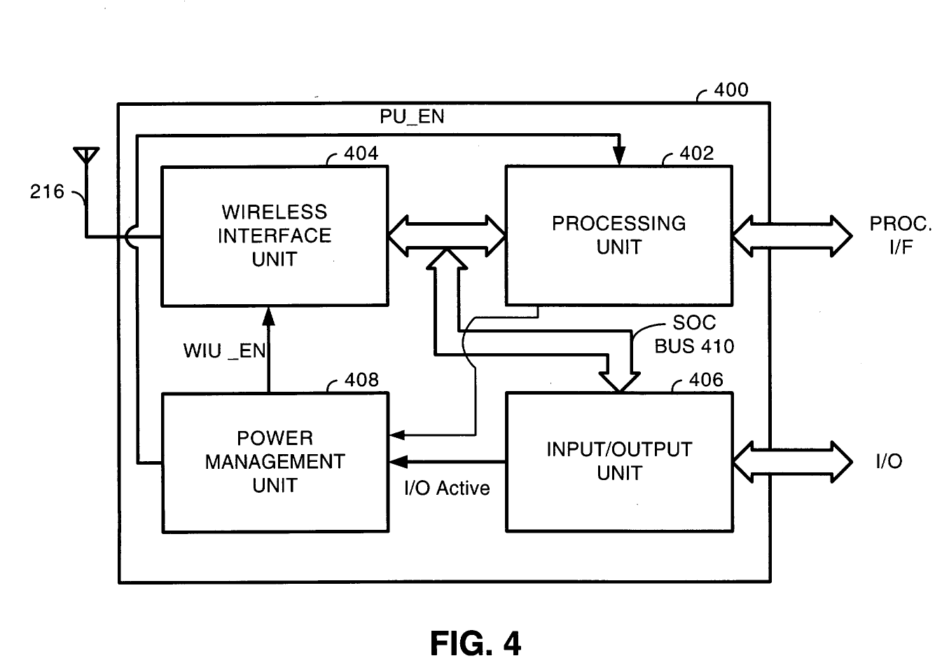

FIG. 4 is a block diagram illustrating a wireless interface device (integrated circuit) constructed according to the present invention. As shown in FIG. 4, the wireless interface device 400 includes a processing unit 402, a wireless interface unit 404, an input/output unit 406, and a power management unit 408. The wireless interface unit 404 couples the wireless interface device 400 to antenna 216. The wireless interface unit 404 can be adapted to operate according to the Bluetooth specification and in particular to the Human Interface Device (HID) portion of the Bluetooth specification. It will be understood by those skilled in the art, however, that the present invention can be adapted to work in conjunction with other wireless interface standards.

Processing unit 402, wireless interface unit 404, and input/output unit 406 couple with one another via a system on a chip (SOC) bus 410. Processing unit 402 includes a processing interface that may be used to couple the processing unit to one or more devices. Input/output unit 406 includes an input/output set of signal lines that couple the wireless interface device 400 to at least one user input device, such as a mouse or the keyboard.

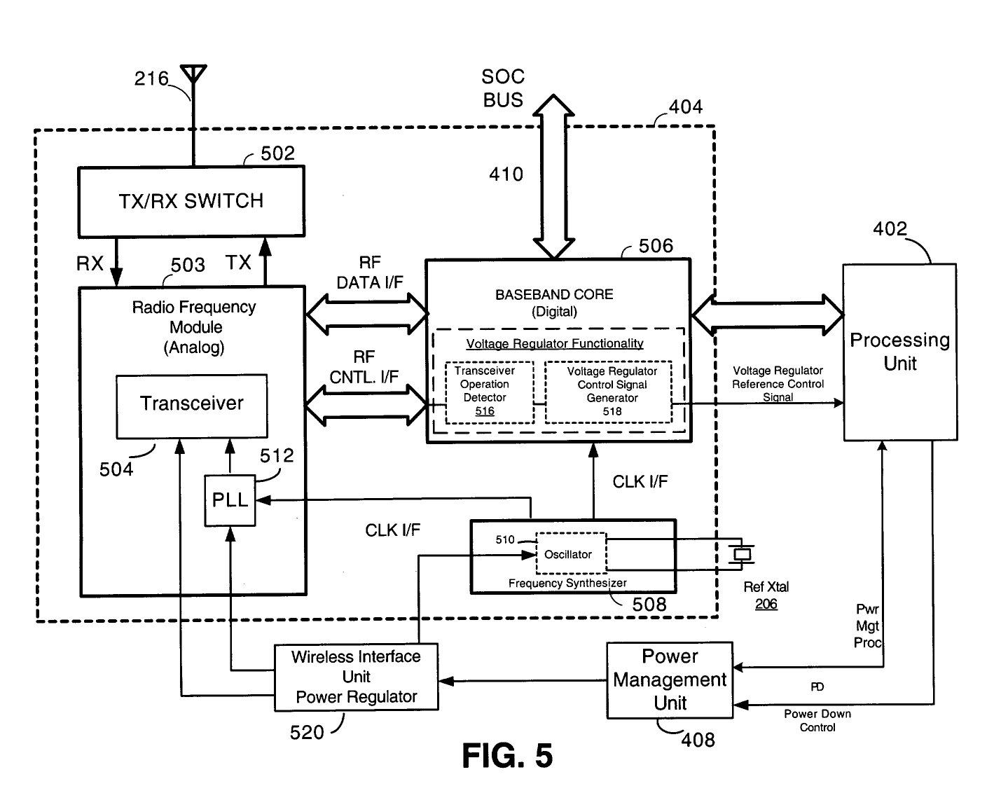

FIG. 5 is a block diagram illustrating a wireless interface unit of the wireless interface device of FIG. 4. The wireless interface unit 404 includes a transmit/receive switch 502, a radio frequency module 503 that comprises a 2.4 GHz transceiver 504, a baseband core 506 which may be compatible with the Bluetooth standard, and a frequency synthesizer 508. Each of these components is generally known in the field and will be described in minimal detail herein.

The transmit/receive switch 502 couples to antenna 216 and switches between transmit and receive operations. The 2.4 GHz transceiver 504 performs all RF front-end operations and operates within a frequency band and on particular channels as are specified by the Bluetooth operating standard. The 2.4 GHz transceiver 504 couples to baseband core 506. Such coupling is performed via an RF control interface and an RF data interface. The RF control interface performs the necessary control operations to guaranty that the 2.4 GHz transceiver 504 and the baseband core 506 will operate consistently within desired operating specifications. The RF data interface transfers both Rx and Tx data between the 2.4 GHz transceiver 504 and the baseband core 506. Frequency synthesizer 508 comprises an oscillator 510 that couples to the external crystal 206 and to the and to the phase-locked loop (PLL) 512. The frequency synthesizer 508 is controlled to provide an RF frequency for the 2.4 GHz transceiver 504 which is used to mix with the baseband signal received from the baseband core during a transmit operation and to mix with the received RF signal during a receive operation. The frequency synthesizer 508 operates in conjunction with the power management unit 408, via the wireless interface unit voltage regulator 520, to provide different clock signals corresponding to different power states as discussed hereinbelow.

The baseband digital unit performs certain voltage regulator functionality to assist in power management functions. A transmitter operation detector 516 and a voltage regulator control signal generator 518 within the baseband core 506 cooperate to detect operation of the transceiver in the RF analog module 503 and to generate a voltage regulator reference control signal for use by the processing unit 402 to process data for the power management unit 408.

The PLL 512 produces a high quality, low phase-noise clock signal for operation of the analog section of the RF analog module 503. As discussed herein, a power management unit 408 is operable to provide power at varying voltage levels depending on the operating mode of the system. A “power down mode” control signal is used to cause the power management unit to switch between dual operating modes, thereby controlling power to the RF module 503 and the frequency synthesizer 508, depending on the specific operating mode.

When the power down mode (PD) signal shown in FIG. 5 is “low,” the system operates in “normal” mode. When the PD signals goes “high,” the system enters a power down mode. In the power down mode, the RF analog module 503 is turned off and the PLL 512 is also turned off. The oscillator 510 is switched to a low power mode, which generates a clock signal of sufficient quality to control the baseband digital core 506. When the PD signal goes low, the system returns to normal mode whereby the power management unit 408 provides a higher voltage power signal to the frequency synthesizer 508, thereby allowing the frequency synthesizer to generate a higher quality clock signal for use by the PLL 512.

By switching between power down mode and normal mode, the system is operable to provide a high quality clock signal for use by the RF analog module 503 when it is operational and to provide a lower power, lower quality clock signal which is sufficient for use by the baseband digital unit 506 when the transceiver 504 in the RF analog module 503 is powered down.

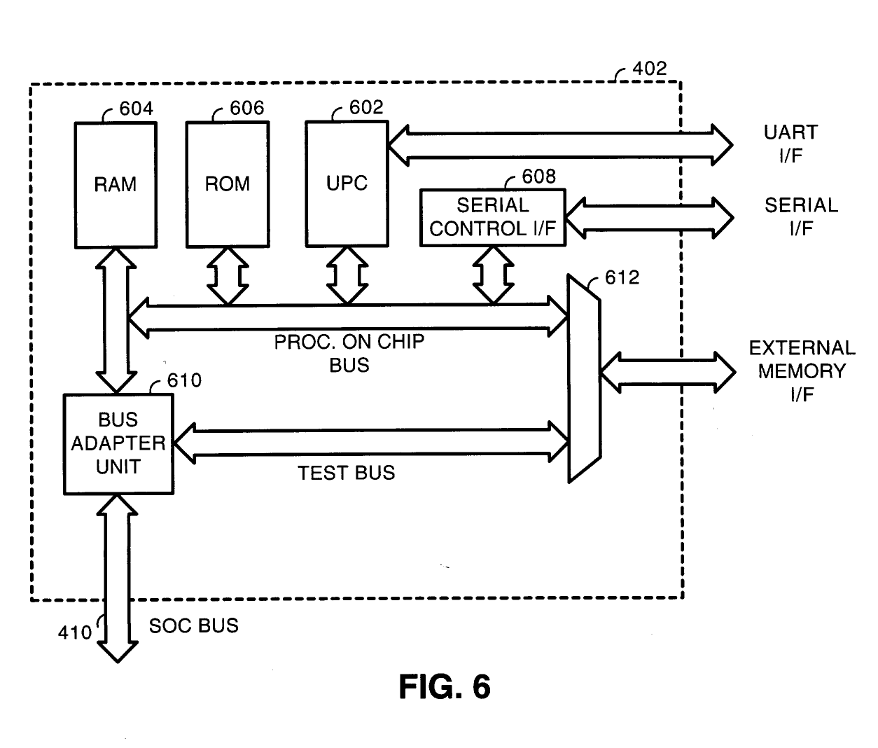

FIG. 6 is a block diagram illustrating a processing unit 402 of the wireless interface device of FIG. 4. The processing unit 402 includes a microprocessor core 602, read only memory 606, random access memory 604, serial control interface 608, bus adapter unit 610, and multiplexer 612. The microprocessor core 602, ROM 606, RAM 604, serial control interface 608, bus adapter unit 610, and multiplexer 612 couple via a processor on a chip bus. Multiplexer 612 multiplexes an external memory interface between the processor on a chip bus and a test bus. The bus adapter unit 610 interfaces the processor on a chip bus with the SOC bus. The microprocessor core 602 includes a universal asynchronous receiver transmitter interface that allows direct access to the microprocessor core. Further, the serial control interface 608 provides a serial interface path to the processor on a chip bus.

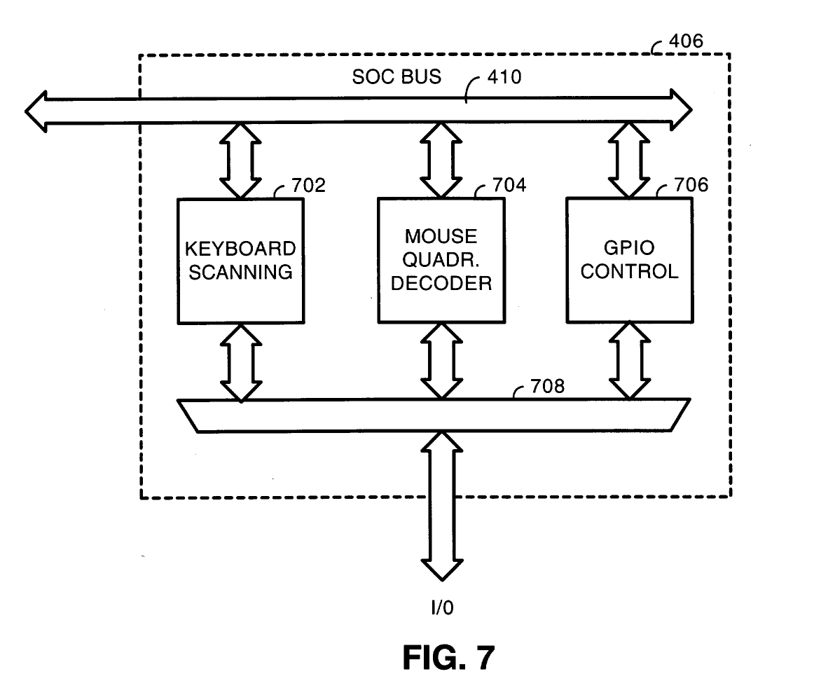

FIG. 7 is a block diagram illustrating an input/output unit 406 of the wireless interface device of FIG. 4. The input/output unit 406 includes a keyboard scanning block 702, a mouse quadrature decoder block 704, and a GPIO control block 706. Each of the keyboard scanning block 702, the mouse quadrature decoder block 704, and the GPIO control block 706 couple to the SOC bus. Further, each of the keyboard scanning block 702, the mouse quadrature decoder block 704, and the GPIO control block 706 couple to I/O via multiplexer 708. This I/O couples to at least one user input device.

In another embodiment of the input/output unit 406, each of the keyboard scanning block 702, the mouse quadrature decoder block 704, and the GPIO control block 706 couples directly to external pins that couple to at least one user input device.

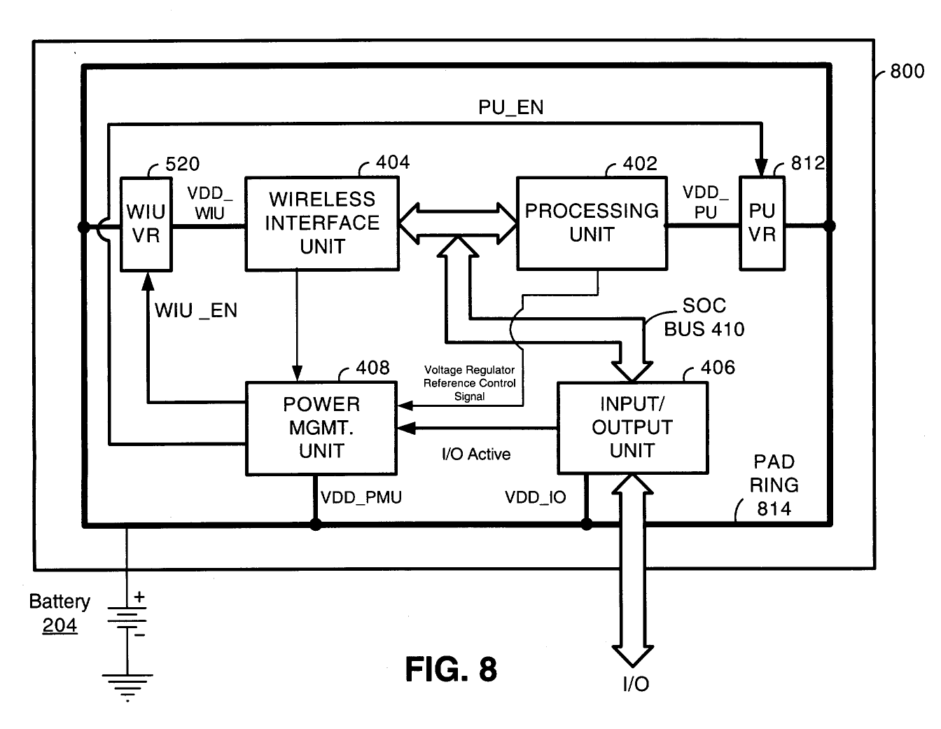

FIG. 8 is a block diagram generally showing the structure of an integrated circuit constructed according to the present invention with particular detail in the coupling of battery power to the units of the device. Integrated circuit 800 of FIG. 8 includes a wireless interface unit 404, processing unit 402, input/output unit 406, and power management unit 408. The processing unit 402, wireless interface unit 404, and input/output unit 406 couple via a SOC bus 410. Further, as was previously described, input/output unit 406 couples to at least one user input device via I/O connection.

With the integrated circuit 800 of FIG. 8, a pad ring 814 surrounds a substantial portion of the components of the integrated circuit. The pad ring 814 couples directly to battery 204, which powers the pad ring. Further, input/output unit 406 and power management unit 408 couple directly to pad ring 814 to receive their power and voltage. However, processing unit 402 couples to pad ring 814 via processing unit voltage regulation circuitry 812. Further, the wireless interface unit 404 couples to pad ring 814 via wireless interface unit voltage regulation circuitry 520. The processing unit voltage regulation circuitry 812 is controlled by the power management unit 408 via control signal PU_EN. Further, the wireless interface unit voltage regulation circuitry 520 is controlled by the power management unit 408 using control signal WIU_EN.

The integrated circuit operates in four different power-conserving modes: (1) busy mode; (2) idle mode; (3) suspend mode; and (4) power down mode. Busy mode, idle mode, and suspend mode are described in the Bluetooth specification. However, power down mode is unique to the present invention.

In busy mode mode, the Master (host computer) is actively polling the HID (wireless mouse, wireless keyboard, etc.) for data at a polling rate near 100 polls/second, or about once every 16 slot times. Continued user activity (keypad strokes, mouse motion, button presses, etc.) keeps the HID in busy mode. If there has been no activity for a few seconds (determined by particular settings), operation transitions to idle mode.

In idle mode, the HID requests the master (serviced host) to enter SNIFF mode with a SNIFF interval that is chosen based on desired latency and average power consumption. In one operation, the SNIFF interval is 50 ms, or about every 80 slot times. Although the HID can transition to I/O Active immediately after an event, it may have to wait up to 100 mS to transmit its data to the host, and therefore must have enough buffer space to store 100 mS of events. If an event occurs, the HID requests the master to leave SNIFF mode. If there is no further activity for a longer period, the HID transitions from idle mode to suspend mode Then, the HID is parked.

In suspend mode, a longer beacon interval can be used for a lower power state. When in suspend mode, any user input detected will result in the HID requesting to be unparked and transitioned back to the busy mode. When the HID is parked, it consumes less power than when the host is in SNIFF mode since the HID does not have to transmit. In suspend mode, the HID just listens to the beacons to remain synchronized to the master's frequency hopping clock. As long as the master continues transmitting (meaning the host is not turned off) the HID will remain in suspend mode. If link loss occurs due to the host being turned off without warning, or the host moving out of range, the Lost Link state will be entered.

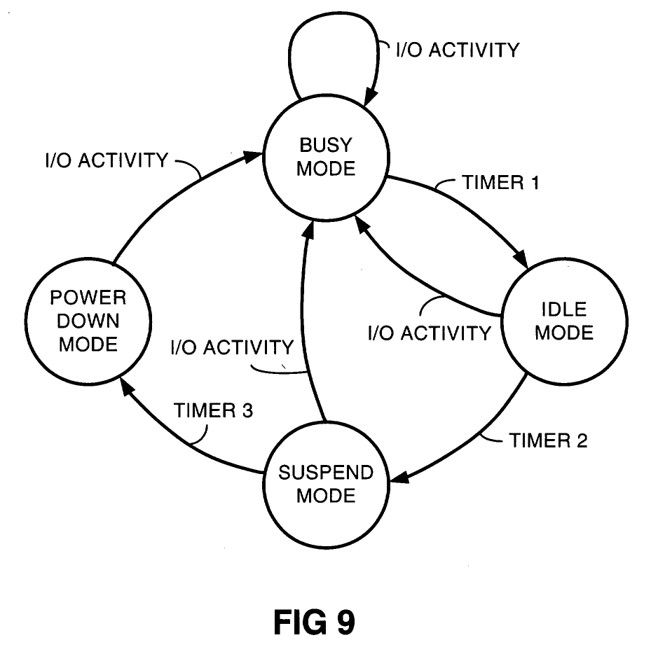

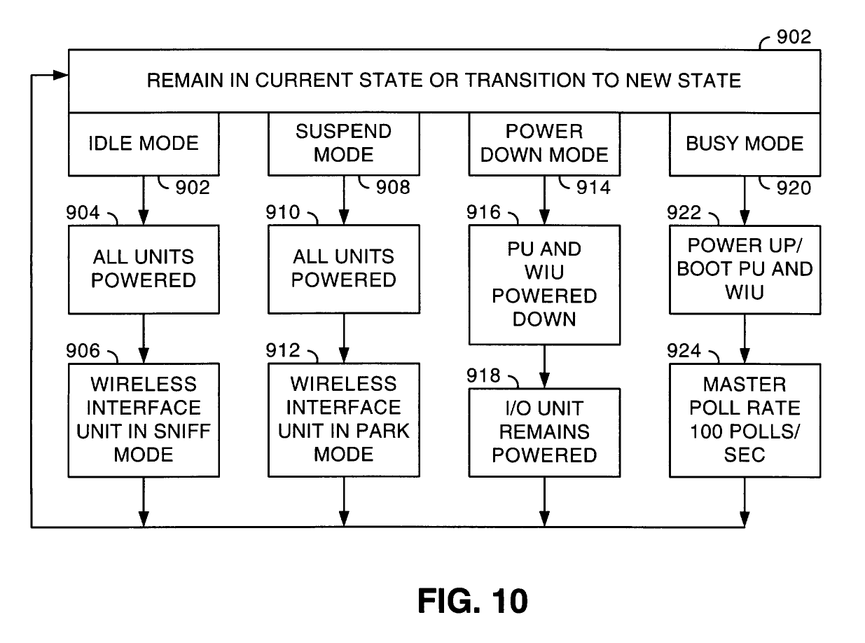

According to the present invention, the power down mode is also supported. In the power down mode, the power management unit 408 operates the processing unit voltage regulation circuitry 812 and the wireless interface unit voltage regulation circuitry 520 to power down the processing unit 402 and wireless interface unit 404, respectively. These states of operation will be described further with reference to FIGS. 9 and 10.

FIG. 9 is a logic diagram illustrating operation according to the present invention. As illustrated in FIG. 9, a wireless interface device operating according to the present invention operates in four separate power-conserving modes. These power conservation modes include the busy mode, the idle mode, the suspend mode and, the power down mode. The state diagram of FIG. 9 shows how each of these modes is reached during normal operation.

When the wireless interface device is initially powered up, it enters the busy mode of operation. In the busy mode of operation, all features and wireless operations of the wireless interface device are enabled. As long as I/O activity continues, the wireless interface device remains in the busy mode. However, after expiration of a first timer with no I/O activity, the operation moves from the busy mode to the idle mode. Operation will remain in idle mode until the expiration of a second timer or until I/O activity occurs.

If while in the idle mode I/O activity occurs, operation returns to the busy mode. If in the idle mode, if timer 2 expires with no additional I/O activity, suspend mode is entered. While in suspend mode, if I/O activity occurs, operation returns to busy mode. However, if in suspend mode, no additional I/O activity occurs until the expiration of a third timer, power down mode is entered. While in the power down mode, operation will remain in the power down mode until I/O activity occurs. When I/O activity occurs, operation of the wireless interface device will move from the power down mode to the busy mode.

FIG. 10 is a logic diagram illustrating operation according to the present invention in controlling the power consumption of a serviced device. As shown in FIG. 10, once operation in a particular power conservation state, e.g., busy mode, idle mode, suspend mode, and power down mode has commenced, operation will remain in that state until expiration of respective timer or I/O activity occurs (step 902).

When power conservation operation occurs to move from the busy mode to the idle mode (step 902), all portions of the wireless interface device remain powered (step 904). However, in the idle mode, the wireless interface unit enters a sniff mode in which some of its operations are reduced. Such operations were previously described with reference to FIG. 9. Further, additional information regarding this mode is available in the Bluetooth HID standard.

When the operation of the wireless interface device transitions from the idle mode to the suspend mode (step 908) all portions of the wireless interface device remain powered (step 910). However, the wireless interface unit of the wireless interface device enters the park mode, which consumes even less power than does the wireless interface unit when in the sniff mode.

When in the suspend mode if an additional timer or inactivity period expires, the wireless interface device will transition to the power down mode (step 914). In the power down mode, the processing unit and wireless interface unit will be powered down (step 916). This power down operation will be performed in one embodiment by simply disconnecting a voltage source from the processing unit and the wireless interface unit. One such technique for doing this is described with reference to FIG. 8. In the power down mode, the input/output unit 406 unit will continue to be powered to allow it to sense the state of the user input device lines.

Finally, from any of the reduced power operating states, when I/O activity is sensed by the input/output unit 406, the wireless input device will transition back to the busy mode (step 920). When such operation occurs, if the components have been powered down, they will be powered up and will go through their boot operations (step 922). Then, in the busy mode, the wireless interface unit will operate in its normal state in which the master wireless device, i.e., wirelessly enabled host will poll the wireless interface device at 100 times per second. From each of steps 906, 912, 918, and 924, operation returns to step 902 wherein the current power conservation state will be kept until another event occurs.

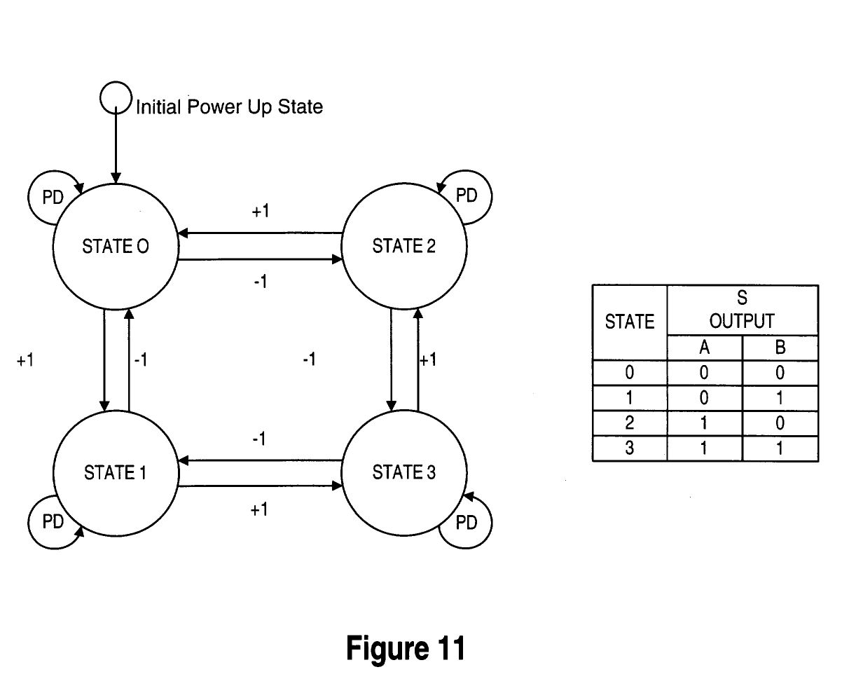

FIG. 11 is an illustration of the possible state transitions for quadrature signals relating to motion of an optical scroll wheel in accordance with the present invention. As a scroll wheel moves in a particular direction, the quadrature outputs transition from one state to another in accordance with the table shown in FIG. 11. For example, if the scroll wheel starts in state SO and is transitioning in the “negative” direction, it will transition through states S2, S3, S1, etc. It is not allowed for a transition from S0 to S3. Rather, it is necessary for the wheel to transition through state S2. The PD signal indicates that the quadrature outputs remain in the same state when the system is “powered-down” and the last state before power down will be the starting state when the system is powered-up.

FIG. 12A is a timing diagram illustrating a prior art timing sequence for generating interrupt signals in response to transitions of quadrature signals relating to the motion of an optical scroll wheel in accordance with the present invention. As can be seen, in the prior art, an interrupt is generated for each state transition. In a wireless system, as discussed herein, many parts of the wireless interface will be powered down during periods of inactivity to preserve battery power. There are many operating conditions and environmental factors that can create a false indication that the scroll wheel has moved thereby causing the wireless interface to power up in response to an erroneous signal, thereby wasting valuable battery life.

FIG. 12B is a timing diagram illustrating a timing sequence for generating interrupt signals in response to transitions of quadrature signals relating to the motion of an optical scroll wheel in accordance with the present invention. In the timing sequence of the present invention, an interrupt is generated only when the I/O unit detects that the scroll wheel has transitioned through two successive states in either the positive or negative direction. For example, if the scroll wheel starts at state SI and is transitioning in the “positive” direction, an interrupt will be generated only after the quadrature outputs indicate that the wheel has transitioned through state S3 and has also transitioned to state S2. By requiring at least two successive state transitions, the system is less susceptible to unnecessary power up of system components in response to false detection of quadrature transitions.

The invention disclosed herein is susceptible to various modifications and alternative forms. Specific embodiments, therefore, have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A wireless interface device that services communications between a wirelessly enabled host and a wireless input device having a scroll wheel, comprising:
a wireless interface unit that wirelessly interfaces with the wirelessly enabled host;
a processing unit operably coupled to the wireless interface unit;
an input/output unit operably coupled to the wireless interface unit and to the processing unit, wherein the input/output unit also operably couples to the at least one user input device;
a power management unit operably coupled to the wireless interface unit, the processing unit, and the input/output unit, wherein the power management unit controls the power consumption of the wireless interface device by:
powering down the wireless interface unit and the processing unit during reduced power operations; and
powering up the wireless interface unit and the processing unit based upon detection of a plurality of quadrature signal state transitions indicating activity by the scroll wheel.

2. The wireless interface device of claim 1, wherein said plurality of quadrature signal state transitions comprised two successive state transitions indication continuous motion of said scroll wheel in a single direction.

3. The wireless interface device of claim 1, further comprising processing unit voltage regulation circuitry that couples the processing unit to a voltage source, wherein the power management unit controls the operation of the processing unit voltage regulation circuitry to controllably power the processing unit.

4. The wireless interface device of claim 1, wherein the wireless interface device enters one of a plurality of power consumption operating states comprising:
busy mode in which all components of the wireless interface device are powered and operational;
idle mode in which the wireless interface unit performs first power conserving operations;
suspend mode in which the wireless interface unit performs second power conserving operations; and
power down mode in which the wireless interface unit and the processing unit are powered down.

5. A wireless interface device that services communications between a wirelessly enabled host and user input device having a scroll wheel, the wireless interface device comprising:
a wireless interface unit that wirelessly interfaces with the wirelessly enabled host;
a processing unit operably coupled to the wireless interface unit;
an input/output unit operably coupled to the wireless interface unit and to the processing unit, wherein the input/output unit also operably couples to the user input device, and wherein said input/output unit is operable to detect state transitions of quadrature signals generated by said scroll wheel of user input device; and
a power management unit operably coupled to the wireless interface unit, the processing unit, and the input/output unit, wherein the power management unit controls the power consumption of the wireless interface device by causing the wireless interface to enter one of a plurality power conservation states after a period of inactivity of said user device.

6. The wireless interface device of claim 5, wherein the power management unit powers down the wireless interface unit and the processing unit after at least one inactivity period during which the input/output unit fails to detect any state transitions of quadrature signals generated by said user input device.

7. The wireless interface device of claim 6, wherein the power management unit powers up the wireless interface unit and the processing unit after said input/output unit detect at least two successive state transitions of quadrature signals generated by said user input device.

8. A user input device comprising:
a computer mouse having a housing with a scroll wheel journaled for rotation therein;
quadrature signal generation circuitry operable to detect rotation of the scroll wheel and to generate quadrature output signals in response thereto;
quadrature signal detection circuitry operable to detect the quadrature output signals and to generate an I/O activation signal after detection of at least two successive state transitions of quadrature signals generated by the quadrature signal generation circuitry.

9. The user input device of claim 8, wherein the I/O activation signal causes the user input device to transition from a low power state to a busy state.

10. A method of detecting rotation of a scroll wheel in a user input device, comprising:
generating quadrature signals in response to rotation of the scroll wheel;
detecting the quadrature signals; and
generating an I/O activation signal after detection of at least two successive state transitions of the quadrature signals.

11. The method of claim 10, wherein the I/O activation signal causes the user input device to transition from a low power state to a busy state.

12. A method of detecting movement of a scroll wheel in a user input device, comprising:
detecting a first signal indicating at least one change in quadrature state of the output signal from a detection circuit operable to detect rotation of the scroll wheel,
detecting a second change in quadrature state from the output of a detection circuit,
comparing the first and second changes in quadrature state to determine whether the scroll wheel has rotated through two successive quadrature states indicating rotation in a single direction; and
generating an I/O activation signal after detection of at least two successive state transitions of the quadrature signals indicating rotation of the scroll wheel in a single direction.

13. The method of claim 12, wherein the I/O activation signal causes the user input device to transition from a low power state to a busy state.

14. A system that services communications between a wirelessly enabled host and at least one user input device, comprising:
a wireless interface unit that wirelessly interfaces with the wirelessly enabled host;
a processing unit operably coupled to the wireless interface unit;
an input/output unit operably coupled to the wireless interface unit and to the processing unit, wherein the input/output unit also operably couples to the user input device;
a power management unit operably coupled to the wireless interface unit, the processing unit, and the input/output unit, wherein the power management unit controls the power consumption of the system; and
a user input device, comprising:
a computer mouse having a housing with a scroll wheel journaled for rotation therein;
quadrature signal generation circuitry operable to detect rotation of the scroll wheel and to generate quadrature output signals in response thereto;
quadrature signal detection circuitry operable to detect the quadrature output signals and to generate an I/O activation signal after detection of at least two successive state transitions of quadrature signals generated by the quadrature signal generation circuitry.

15. The system of claim 14, wherein the power management unit powers down the wireless interface unit and the processing unit after at least one inactivity period during which the user input device is inactive with respect to the input/output unit.

16. The system of claim 14, wherein the power management unit controls the power consumption of the system by:
powering down the wireless interface unit and the processing unit during reduced power operations; and
based upon notification received from the input/output unit indicating activity by the user input device, powering up the wireless interface unit and the processing unit.

17. The system of claim 16, wherein the system enters one of a plurality of power consumption operating states comprising:
busy mode in which all components of the wireless interface device are powered and operational;
idle mode in which the wireless interface unit performs first power conserving operations;
suspend mode in which the wireless interface unit performs second power conserving operations; and
power down mode in which the wireless interface unit and the processing unit are powered down.

18. A user input device, comprising:
means for generating quadrature signals in response to movement of the rotation of the scroll wheel;
means for detecting the quadrature signals; and
means for generating an I/O activation signal after detection of at least two successive state transitions of the quadrature signals.

19. The user input device of claim 18, wherein the I/O activation signal causes the user input device to transition from a low power state to a busy state.

20. A system for detecting movement of a scroll wheel in a user input device, comprising:
means for detecting a first signal indicating at least one change in quadrature state of the output signal from a detection circuit operable to detect rotation of the scroll wheel,
means for detecting a second change in quadrature state from the output of a detection circuit,
means for comparing the first and second changes in quadrature state to determine whether the scroll wheel has rotated through two successive quadrature states indicating rotation in a single direction; and
means for generating an I/O activation signal after detection of at least two successive state transitions of the quadrature signals indicating rotation of the scroll wheel in a single direction.

21. The method of claim 20, wherein the I/O activation signal causes the user input device to transition from a low power state to a busy state.
